(19) United States
(12) Patent Application Publication
(10) Pub. No.: US 2020/0109586 A1
(43) Pub. Date: Apr. 9, 2020

(54) DOOR APPARATUS

(71) Applicant: HP INDIGO B.V., Amstelveen (NL)

(72) Inventors: Noam Inbal, Ness Ziona (IL); Ella Blecher, Ness Ziona (IL); Anna Blakhman, Ness Ziona (IL)

(73) Assignee: HP INDIGO B.V., Amstelveen (NL)

(21) Appl. No.: 16/615,741

(22) PCT Filed: Jun. 14, 2017
(86) PCT No.: PCT/EP2017/064643

§ 371 Date: Nov. 21, 2019

(51) Int. Cl. E05D 15/58; E06B 3/50; E05C 19/16

(52) U.S. Cl. CPC E05D 15/58; E06B 3/509; E05Y 2900/20; E05Y 2900/132; E05C 19/16

(57) ABSTRACT

In one example, a door apparatus is described, having a door leaf (102) part including a first door leaf portion (104a) and a second door leaf portion(104b), and having a pivot mechanism (106) defining a pivot axis connected to the first door leaf portion. The second door leaf portion is slidably movable with respect to the first door leaf portion between a first position, in which the door leaf part extends a first distance from the pivot axis, and a second position in which the door leaf part extends a second distance from the pivot axis, the first distance being larger than the second distance, and the pivot mechanism is to enable the door leaf part to pivot about the pivot axis when the second door leaf portion is in the second position.

### BACKGROUND

Doors typically provide selective access to or through an aperture, and may be arranged in closed configurations or open configurations. In a closed configuration the door inhibits or prevents access to or through the aperture by means of a physical barrier partially or wholly blocking the aperture. In an open configuration, the physical barrier is partially or wholly removed from the aperture, enabling access.

### BRIEF DESCRIPTION OF THE DRAWINGS

FIG. 1 is a block diagram of a door apparatus according to an example;

FIGS. 2a to 2c are plan diagrams of the door apparatus in different configurations;

FIG. 3a is a schematic diagram showing a perspective view a door leaf part of the door apparatus;

FIG. 3b is a schematic drawing showing an exploded perspective view of a door leaf part of the door apparatus;

FIG. 3c is a schematic drawing showing a perspective view of an internal panel of the door leaf part;

FIG. 4 is a schematic drawing showing a perspective view of an engagement mechanism according to an example;

FIGS. 5a to 5c are front views of different configurations of the door apparatus in an aperture according to an example;

FIGS. 6a to 6c are plan diagrams of a printing system according to an example;

FIGS. 7a to 7c are plan diagrams of a door apparatus according to a first further example; and

FIGS. 8a to 8e are plan diagrams of a door apparatus according to a second further example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

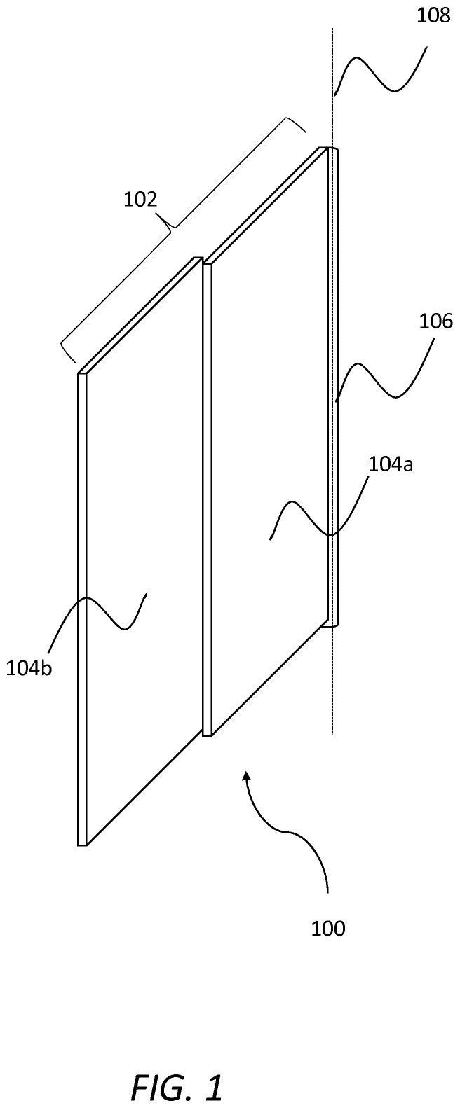

FIG. 1 is a block diagram schematically illustrating the components of an example door apparatus 100. FIG. 1, as well as other figures referenced herein, are schematic diagrams and as such certain components have been omitted to facilitate a description of the example. Actual implementations may vary in practice.

The door apparatus 100 includes a door leaf part 102 comprising a first door leaf portion 104a and a second door leaf portion 104b. The first door leaf portion 104a and the second door leaf portion 104b may be door panels comprised of metal, plastic, wood or any other suitable material, and are referred to herein as the “first door leaf 104a” and the “second door leaf 104b” respectively. The second door leaf 104b is slidably movable with respect to the first door leaf 104a, as is described in more detail below. The door apparatus also includes a pivot (rotation) mechanism 106 defining a pivot (rotation) axis 108 and connected to the first door leaf 104a. The pivot mechanism 108 may be a hinge mechanism, for example. The pivot mechanism 108 is connected to the first door leaf 104a by a connection means (not shown) such as screws and threads, for example.

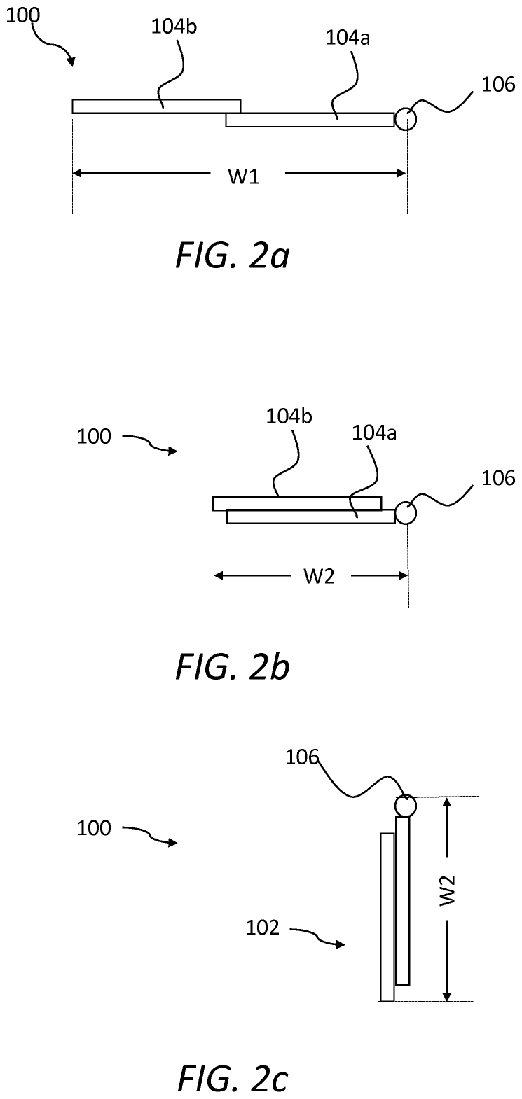

FIGS. 2a, 2b and 2c are schematic plan views of the door apparatus 100a. In FIG. 2a, the second door panel 104b is in a first position (herein referred to as “the closed position”) such that the door leaf part 102 extends a first distance from the pivot axis 108 defined by the pivot mechanism 106, and has a first width W1. In FIG. 2b, the second door leaf 104b is in a second position (herein referred to as “the open position”) such that the door leaf part 102 extends a second, shorter, distance from the pivot axis defined by the pivot mechanism, and has a second width W2. The second door leaf 104b is slidably movable between the closed position and the open position, so that the door apparatus may selectively be configured in a first configuration, as shown in FIG. 2a, or a second configuration, as shown in FIG. 2b.

When the second door panel 104b is in the open position, the pivot mechanism 106 enables the door leaf part 102 to pivot (rotate) about the pivot axis 108. FIG. 2c shows the door apparatus 100 with the door leaf part 102 having pivoted through approximately 90 degrees from the configuration shown in FIG. 2b.

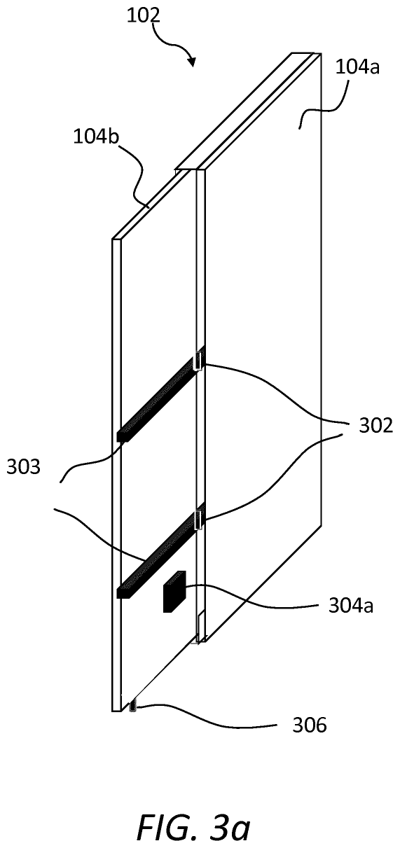

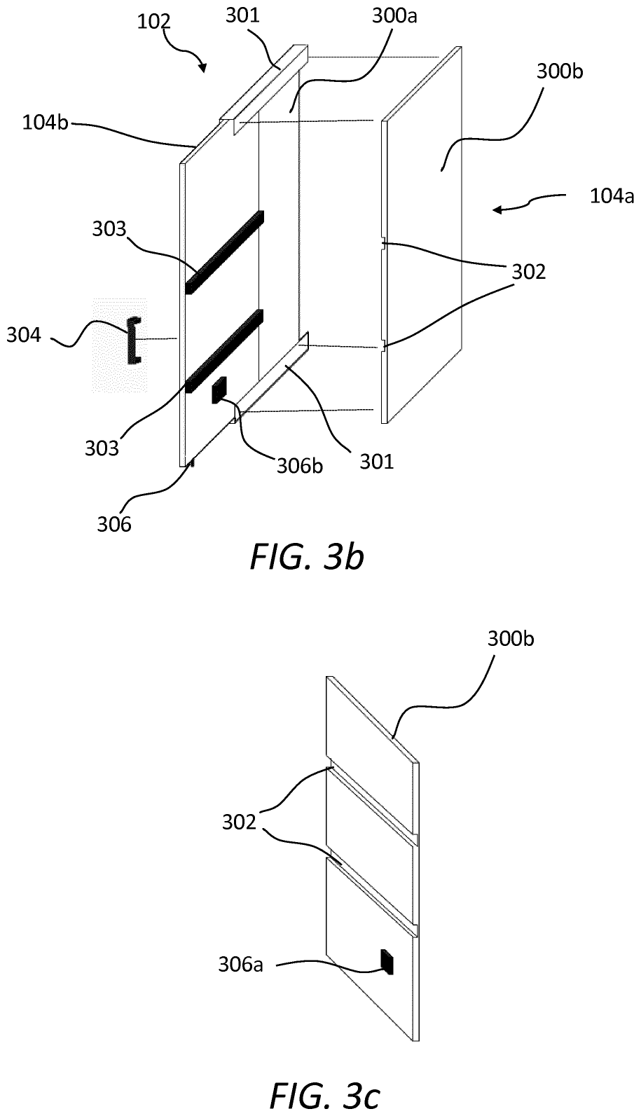

FIGS. 3a and 3b are schematic drawings showing, respectively, a perspective view and an exploded perspective view of a door leaf part 102 according to an example. The first door leaf 104a in this example comprises a first panel 300a and a second panel 300b, herein referred to as the “exterior panel 300a” and the “interior panel 300b” respectively. FIG. 3c shows a perspective view of the interior panel 300b. A sliding mechanism is provided to enable the second door leaf 104b to engage with the first door leaf 104a. In this example, the sliding mechanism includes rail portions 301 affixed to the top and bottom edges of the exterior panel 300a, slits 302 provided in the interior panel 300b and corresponding slats 303 on second door leaf 104b which mate with the slits 302. The sliding mechanism enables the second door leaf 104b to be moved in a lateral direction with respect to the first door leaf 104a. The second door leaf 104b includes a handle 304 via which an operator, such as a human operator, may compel the second door leaf 104b to move between the open and closed positions.

The door leaf part 102 according to this example also includes a holding mechanism to inhibit sliding movement of the second door during pivoting of the door leaf part 102. In this example, the holding mechanism comprises a first magnet 306a on the interior panel 300b and a second magnet 306b on the second door leaf 104b. The first magnet 306a and second magnet 306b are positioned so as to come into contact or close proximity when the second door leaf is in the open position. The attraction between the magnets 306a, 306b thus inhibits the second door leaf 104b moving away from the open position during pivoting of the door leaf part 102. In other examples, different holding mechanisms may be used, such as latch mechanisms.

The second door leaf 104b includes a protrusion 306, herein referred to as a “pin 306”. Functions of the pin 306 are described below.

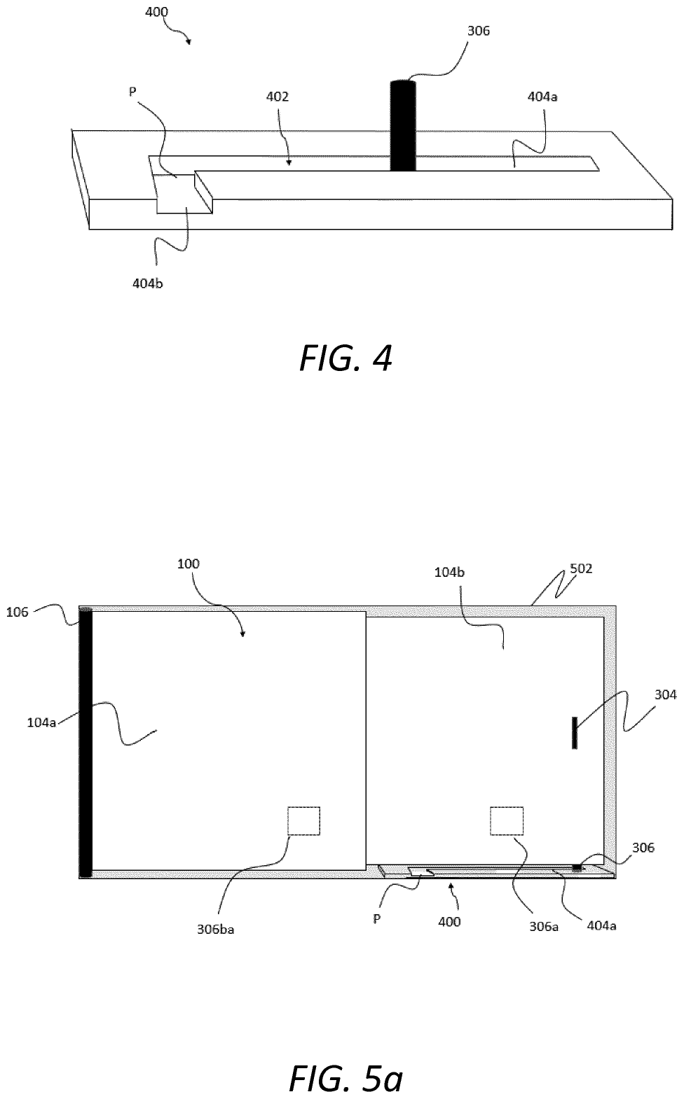

In some examples, the door apparatus 100 includes an engagement mechanism which prevents or inhibits pivoting of the door leaf part 102 when the door leaf part 102 is not in the open position. FIG. 4 is a schematic block diagram showing a perspective view of an engagement mechanism 400 according to an example. The engagement mechanism 400 includes the pin 306 and a channel 402 configured to receive the pin 306. The channel 402 includes a first channel part 404a whose length is substantially parallel to the direction of movement of the second door leaf 104b when moving between the open and closed positions. The channel also includes a second channel part 404b whose length is substantially perpendicular to the first channel part 404a. The first channel part 404a and the second channel part 404b intersect at an intersection point P, which corresponds to the open position of the second door leaf 104b.

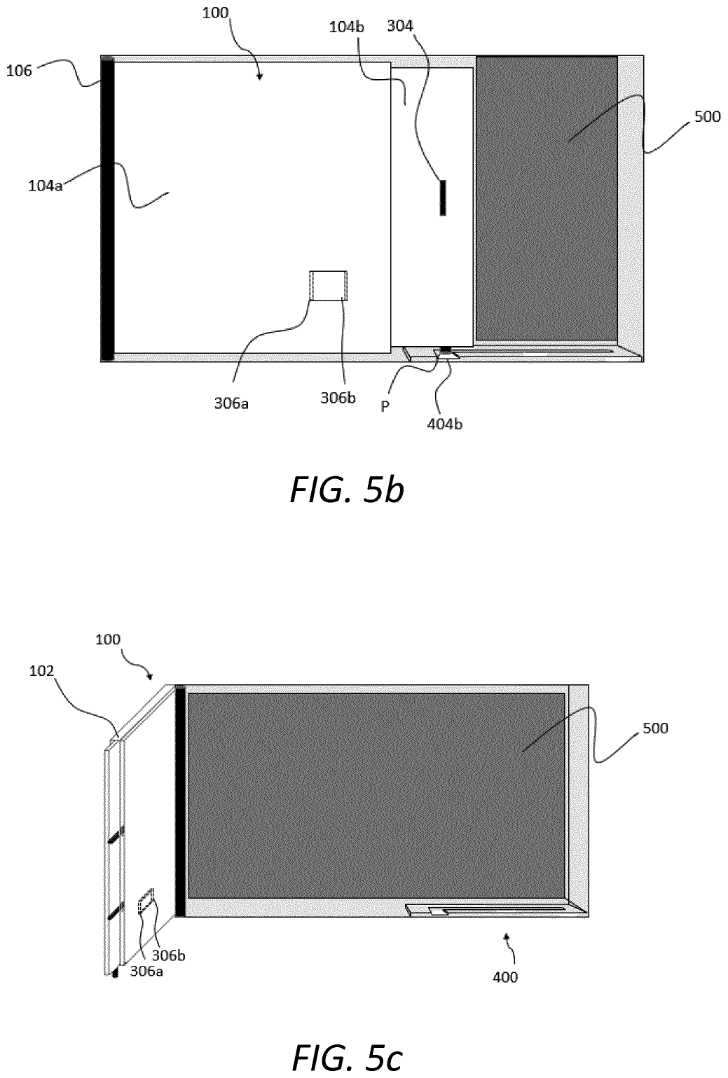

FIGS. 5a, 5b and 5c are front views of a door apparatus 100 in an aperture 500 according to an example. The aperture 500 may be defined by a frame 502, for example a door frame, arranged around the perimeter of the aperture.

FIG. 5a shows a first configuration in which the second door leaf 104b is in the closed position, with the pin 306 located at an end of the first channel part 404a opposing the intersection point P. In this configuration, the second leaf part 104b is extended away from the pivot mechanism 106 and the door apparatus 100 occupies substantially the whole of the aperture.

FIG. 5b shows a second configuration in which the second door leaf 104b is in the open position, with the pin 306 located at the intersection point P. The second leaf part 104b may be moved from the first configuration and the second configuration by an operator pulling or pushing the handle 304 to move the second leaf part laterally in the aperture 102. In this configuration, the first magnet 306a and second magnet 306b are aligned, holding the second leaf part 104b in the open position. In this configuration, a part of the aperture 500 is not occupied by the door apparatus 104, enabling access to the unoccupied part of the aperture 500.

FIG. 5c shows the door apparatus 100 with the door leaf part 102 pivoted away from the aperture 500, to provide access so substantially the whole of the aperture 500. The door apparatus 100 may be changed from the configuration of FIG. 5b to the configuration of FIG. 5c by the operator pulling the handle 304, for example, so that the pin 306 passes along the second channel part 404b thorough an opening thereof, and then disengages from the channel 402, allowing the door leaf part 102 to pivot freely away from the aperture 500.

The holding mechanism 306a, 306b inhibits sliding movement of the second door leaf 104b during pivoting of the door leaf part 102 way from the aperture 500. This inhibits the door leaf part 102 from extending when pivoted away from the aperture 500 thereby using up space in front of the aperture. Further, it maintains the pin 306 in a position such that it is aligned to engage with the channel 404 when it is pivoted into the aperture 500. The holding mechanism 306a, 306b may be arranged to so that it may be disengaged by the operator in order to move the second door leaf 104b from the open position (as shown in FIG. 5b) to the closed position (as shown in FIG. 5a). For example, in the case that the holding mechanism comprises magnets 306a, 306b, they may be arranged such that the strength of the attractive force between the magnets can be overcome by the operator manually compelling the second door leaf 104b towards the closed position.

Although not shown, the door apparatus 100 may include a stop mechanism to prevent the second door leaf 104b from becoming detached from the first door leaf 104a, in the event that the holding mechanism becomes disengaged during pivoting of the door leaf part 102.

Apparatuses according to the above examples enable selective access to an aperture in a space-efficient manner. Because the width of the door leaf part is adjustable and is reduced prior to pivoting the apparatus to a fully open configuration, the apparatus can be used to selectively cover and uncover an aperture of width greater than the distance available in front of the apparatus to pivot open the apparatus. This may enable the apparatus to be used even where the aperture is in a confined space, such as in a corridor of an industrial apparatus.

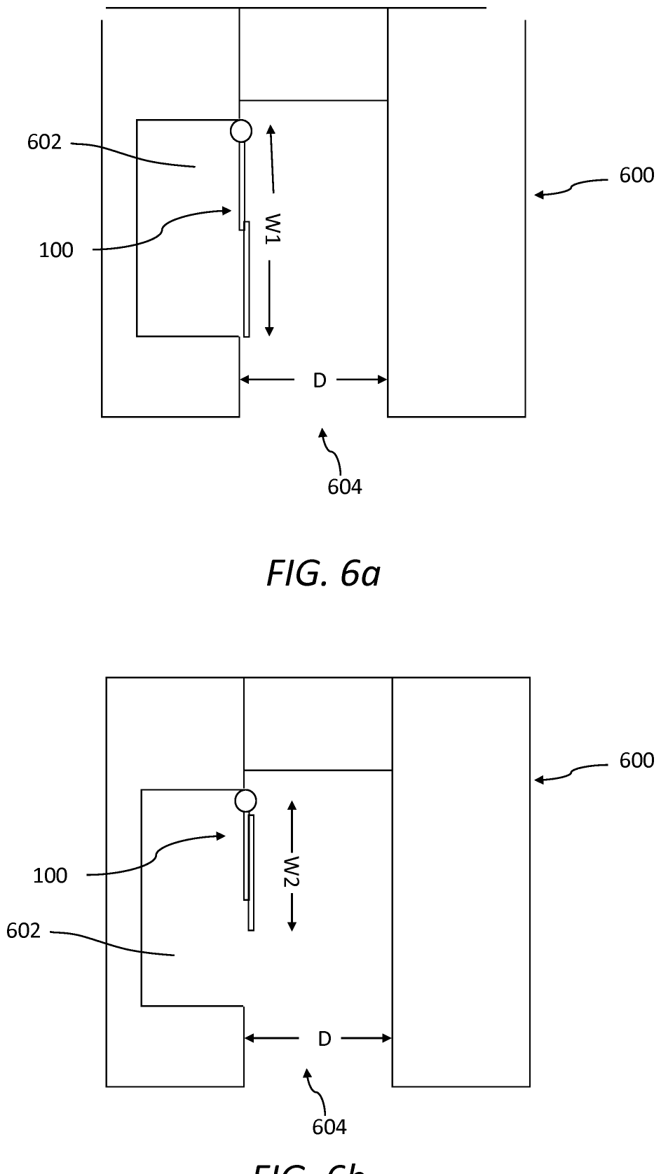

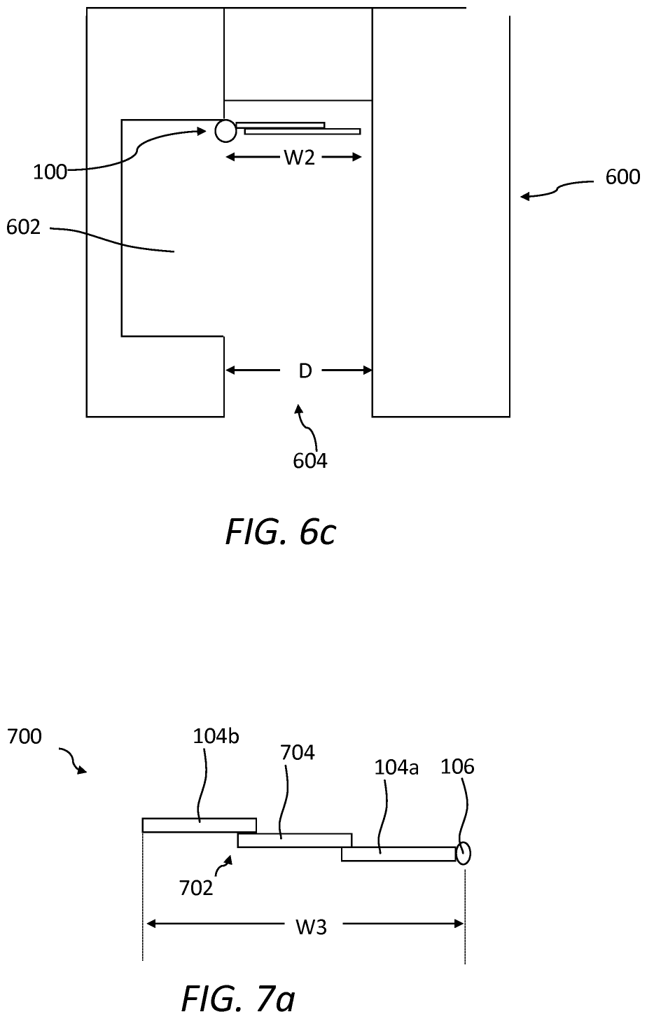

For example, a door apparatus 100 according to any of the above examples may be used to provide access to an aperture in an industrial apparatus. FIGS. 6a, 6b and 6c are schematic drawings showing perspective views of an industrial apparatus 600 according to an example. The industrial apparatus 600 may be a printing system such as an industrial printing machine, for example, and includes an aperture, for example an opening to a utility cabinet 602 in a side wall of a corridor 604. The distance D from the aperture to an opposing side wall of the corridor (the width of the corridor) is less than width of the opening to the utility cabinet 602. A single hinged door with a fixed width, for example, would not be suitable for providing access to the utility cabinet 602 because the side wall opposing the aperture would prevent the door from opening fully.

In contrast, a door apparatus 100 according to the above examples has an adjustable width. Accordingly, the door apparatus 100 can be configured to have a first width W1 substantially equal to the width of the opening of the utility cabinet 602 when access to the utility cabinet 602 is not required, as shown in FIG. 6a. The width of the door apparatus can be reduced to a reduced width W2 as shown in FIG. 6b. This provides partial access to the utility cabinet 602. If full access is required, by arranging that the reduced width W2 is less than the width D of the corridor, the door apparatus 100 can be pivoted into a fully open configuration, as shown in FIG. 6c.

As mentioned above, the door apparatus 100 according to the present examples can be used even where space would be insufficient for a single hinged door for example. It also allows full access to the aperture, whereas arrangements using for example, multiple hinged doors typically include components which obscure part of the aperture even when fully opened. The door apparatus 100 is also easy to operate and simpler than, for example, arrangements using folding doors.

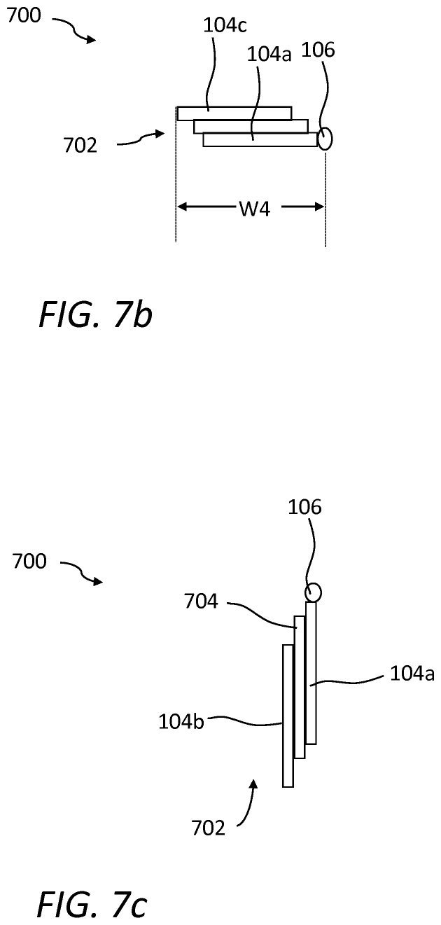

In the above examples, the door leaf part 102 includes two door leafs, namely the first door leaf 102a and a second door leaf 102b. In some examples, the door leaf part 102 includes further door leafs. For example, FIGS. 7a to 7c shown plan views of various configurations of a door apparatus 700 including a door leaf part 702 comprising an intermediate door leaf 704 slidably connected, on one side, to the first door leaf 104a and, on an opposing side, to the second door leaf 104b. The slidable connections may include rails and/or slits and slats as described above in relation to FIGS. 3a to 3c. For example, the second door leaf 104b may be configured to move laterally between exterior and interior panels (not shown) of the intermediate door leaf 704, and slits may be provided on the exterior panel of the intermediate door leaf to mate with the slots 302 provided on the exterior panel 300b of the first door leaf 104a. Thus a “telescopic” door apparatus 700 is provided in which the second door leaf 104b and the intermediate door leaf 704 may be selectively moved laterally with respect to the first door leaf 104a away from the pivoting mechanism 106 to adopt a closed configuration as shown in FIG. 7a, or moved towards the pivot mechanism 106 to adopt an open configuration, as shown in FIG. 7b. In the closed configuration, the intermediate door leaf 704 extends from a position on the first door leaf 104a in a direction away from the pivot mechanism 106, and the second door leaf 104b extends from a position on the intermediate door leaf 702 away from the pivot mechanism 106. In the open configuration, the first door leaf 104a, intermediate door leaf 704 and second door leaf 104c mutually overlap. The engagement means 300 (not shown) may enable the door leaf part to pivot about the pivot axis 308 in the open configuration, as shown in FIG. 7c, and inhibit the door leaf part 102 from pivoting about the pivot axis when the door leaf part 102 is not in the open configuration.

Providing the intermediate door leaf 704 enables the ratio of the width W3 of the door leaf part 702 in the closed configuration of FIG. 7a to the width W4 of the door leaf part 702 in the open configuration of FIGS. 7b and 7c to be larger than the ratio of the corresponding widths of the door leaf part 102 of FIGS. 2a to 2c (W3/W4>W1/W2). Thus the use of the intermediate door leaf 704 further improves the efficiency of use of space.

While in the example of FIGS. 7a to 7c, a single intermediate door leaf is used, it will be appreciated that in other examples, any number of intermediate door leafs 704 can be used

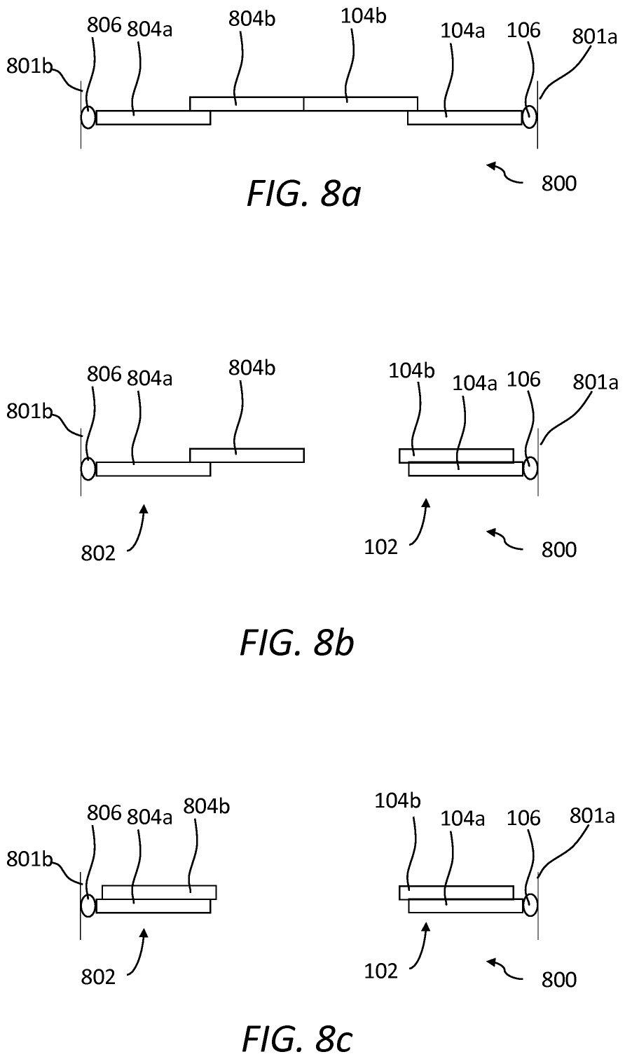

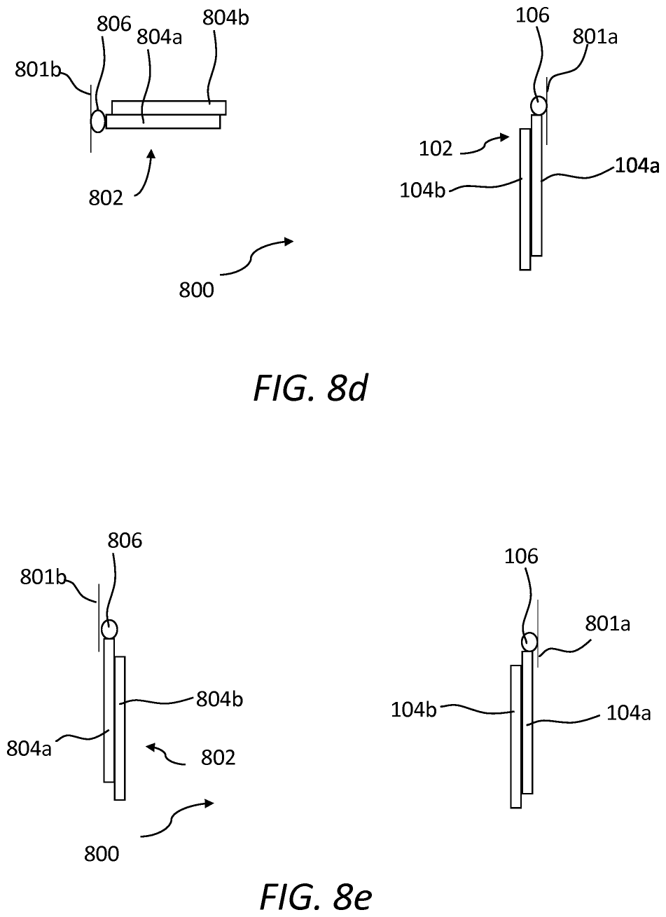

In the above examples, a door apparatus 100 having a single leaf part 102 and pivot mechanism 106 is used to selectively provide access to an aperture. However, in other examples, multiple door leaf parts having adjustable width may be used in conjunction with multiple pivot mechanisms. For example, FIGS. 8a to 8e show plan views of various configurations of a door apparatus 800 in an example. In this example, the door apparatus 800 includes a frame having a first frame end 801a and a second, opposing, frame end 801b. The door apparatus 800 includes a pivot mechanism 106 and a door leaf part 102 including a first door leaf 104a and second door leaf 104b as described above. The pivot mechanism is at the first end 801a of the frame. The door apparatus 800 also includes a further pivot mechanism 806 at the second end 801b of the frame, and a further door leaf part 802 comprising a third door leaf 804a and a fourth door leaf 804b. The further pivot mechanism 806, third door leaf 804a and fourth door leaf 804b may be configured to pivot and slide in opposed directions to, but otherwise have the same features and relationships as those described in the above examples in relation to the pivot mechanism 106, first door leaf 104a and second door leaf 104b.

The above arrangements are to be understood as illustrative examples. Further arrangements and modifications to those arrangements are envisaged. For example, while in the above examples, the holding mechanism included a magnet 306a located on the interior panel 300a, in some examples the magnet may be located on the exterior panel 300b, or another part of the door apparatus. Although in the above examples, the door leaf part 102 included an exterior panel 302a and an interior panel 300b, in some examples it includes on only one panel.

In the above examples, the engagement mechanism 400 included a pin 306 protruding from the second door leaf 104b arranged to engage with a channel 404 in a door frame 502. In other examples, the pin protrudes from the door frame 502 and the channel is in the door leaf 104b. While in the above examples the pin and channel are provided on a bottom surface of the second door leaf 104b and a bottom part of the door frame 502, in other examples the pin and channel are provide on an upper surface of the door leaf 104b and a top part of the door frame 502. Further, multiple engagement mechanisms may be used, for example one on an upper part of the door apparatus 100 and another on a lower part of the door apparatus 100. In still other examples, a wheel or other mechanism may be used in place of the pin 306.

It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

What is claimed is:

1. A door apparatus, comprising:
a door leaf part including a first door leaf portion and a second door leaf portion; and
a pivot mechanism defining a pivot axis connected to the first door leaf portion,
wherein the second door leaf portion is slidably movable with respect to the first door leaf portion between a first position, in which the door leaf part extends a first distance from the pivot axis, and a second position in which the door leaf part extends a second distance from the pivot axis, the first distance being larger than the second distance, and the pivot mechanism is to enable the door leaf part to pivot about the pivot axis when the second door leaf portion is in the second position.

2. The apparatus according to claim 1, comprising an engagement mechanism for inhibiting pivoting of the door leaf part when the second door leaf portion is not in the second position.

3. The door apparatus according to claim 2, wherein the engagement mechanism comprises a channel, and the second door leaf portion comprises a protrusion to engage with the channel during movement between the first position and the second position.

4. The door apparatus according to claim 3, wherein the channel comprises a first channel part and a second channel part, the first channel part having a length substantially parallel to a direction of movement of the second door leaf portion during the movement between the first position and the second position, and the second channel part comprises an opening to enable the second door leaf part to be disengaged from the engagement means.

5. The door apparatus according to claim 4, wherein the second channel part has a length substantially perpendicular to the length of the first channel part.

6. The door apparatus according to claim 1, comprising a holding mechanism to inhibit sliding movement of the second door leaf portion during pivoting of the door leaf part.

7. The door apparatus according to claim 6, wherein the holding mechanism is to engage with the second door leaf part when the second door leaf part is in the second position.

8. The door apparatus according to claim 7, wherein the holding mechanism comprises a magnet and/or a latch.

9. The door apparatus according to claim 1, comprising:
a frame, the pivot mechanism being at a first end of the frame;
a further door leaf part including a third door leaf portion and a fourth door leaf portion;
a further pivot mechanism defining a further pivot axis connected to the third door leaf portion, the further pivot mechanism being at a second end of the frame,
wherein the fourth door leaf portion is slidably movable with respect to the third door leaf portion between a third position, in which the door leaf part extends a third distance from the further pivot axis, and a fourth position in which the door leaf part extends a fourth distance from the further pivot axis, the third distance being larger than the fourth distance, and the further pivot mechanism is to enable the door leaf part to pivot about the further pivot axis when the second door leaf portion is in the fourth position.

10. Apparatus to provide access to an aperture, comprising:
a first panel portion;
a second panel portion laterally movable with respect to the first panel portion between a first configuration and a second configuration, wherein, when the second panel portion is in the first configuration, the apparatus occupies substantially the whole of the aperture, and when the second panel portion is in the second configuration, a part of the aperture is not occupied by the apparatus; and
a rotation mechanism to enable rotation of the first panel portion and the second panel portion about an axis when the second panel portion is in the second configuration, to provide access to substantially the whole of the aperture.

11. The apparatus according to claim 10, comprising engaging means which engages with the second panel portion and prevents rotation of the second panel portion when the first second panel portion is not in the second configuration.

12. The apparatus according to claim 10, comprising a third panel portion slidably connected to each of the first panel portion and the second panel portion, wherein:
the first panel portion is connected to the rotation mechanism;
in the first configuration, the third panel portion extends from a position on the first panel portion in a direction away from the rotation mechanism and the second panel portion extends away from a position on the third panel portion in a direction away from the rotation mechanism; and
in the second configuration the first panel portion, second panel portion and third panel portion substantially mutually overlap.

13. An industrial apparatus comprising:
an aperture;
a rotating mechanism at a side of the aperture;
an engagement mechanism; and
a door leaf part extending from the rotating mechanism,
wherein a width of the door leaf part is adjustable between a first width in which door leaf part extends across substantially all of the aperture and a second width, shorter than the first width, the door leaf part engages with the guide structure during adjustment from the first width to the second width, and when the width of the door leaf part is adjusted to have the second width, the door leaf part can be disengaged from the engagement mechanism so that the rotating mechanism enables the door leaf part to rotate away from the aperture.

14. The industrial apparatus according to claim 13, comprising a corridor, wherein the aperture is in a side wall of the corridor and a distance between the aperture and an opposing side wall of the corridor is greater than the second width and less than the first width.

15. The industrial apparatus according to claim 13, wherein the industrial apparatus is a printing system and the aperture is an aperture of a utility cabinet of the printing system.
